(19) United States
(12) Patent Application Publication
(10) Pub. No.: US 2015/0082541 A1
(43) Pub. Date: Mar. 26, 2015

(54) CONNECTOR AND MEDICAL DEVICE SYSTEM INCORPORATING SAME

(71) Applicants: Veso Tijanic, Woodbridge (CA); Joseph Fisher, Thornhill (CA); Bryan Kowalchuk, Oakville (CA); Bryan Drew Miller, Richmond Hill (CA); Kevin Ramkhelawan, Scarborough (CA); Kevin Kowalchuk, Oakville (CA); Cliff Ansel, Thornhill (CA); David Dunn, Toronto (CA); Ludwik Fedorko, Mississauga (CA)

(72) Inventors: Veso Tijanic, Woodbridge (CA); Joseph Fisher, Thornhill (CA); Bryan Kowalchuk, Oakville (CA); Bryan Drew Miller, Richmond Hill (CA); Kevin Ramkhelawan, Scarborough (CA); Kevin Kowalchuk, Oakville (CA); Cliff Ansel, Thornhill (CA); David Dunn, Toronto (CA); Ludwik Fedorko, Mississauga (CA)

(21) Appl. No.: 14/508,594

(22) Filed: Oct. 7, 2014

Related U.S. Application Data
(63) Continuation of application No. 12/990,564, filed on Apr. 15, 2011, now abandoned.
(60) Provisional application No. 61/049,755, filed on May 1, 2008.

(51) Int. Cl. A61G 1/04

(52) U.S. Cl. CPC A61G 1/04
USPC 5/503.1

(57) ABSTRACT

In one aspect, the invention is directed to a connector for connecting a medical device to a support member on a patient support device, such as a stretcher. The connector includes a support member connector that is fixedly connectable to the support member and a device connector for fixedly connecting to the medical device. The device connector is movable relative to the support member connector between a first position wherein the device connector is positioned to hold the medical device adjacent the patient support device and a second position that is inboard of the first position relative to the patient support device.

### CROSS-REFERENCE TO RELATED APPLICATIONS

This application is a continuation of co-pending U.S. patent application Ser. No. 12/990,564, filed on Apr. 15, 2011, which is a national phase filing, under 35 U.S.C. §371(c), of International Application No. PCT/CA20091000589, filed May 1, 2009, which claims the benefit, under 35 U.S.C. §119(e), of U.S. Provisional application No. 61/049,755, filed May 1, 2008. The disclosures of all of the aforementioned applications are incorporated herein by reference in their entireties.

### FIELD OF THE INVENTION

The present invention relates to connectors and more particularly to connectors for holding medical devices on stretchers, particularly for use in confined space such as a helicopter.

### BACKGROUND OF THE INVENTION

Stretchers and other support devices used to transport patients are often used to hold medical equipment. In some situations it is desirable to be able to move the medical devices between two or more positions to permit access to the patient, or to permit a person to pass by in a confined space. Structures proposed for holding medical devices in these environments have disadvantages and so new structures that address one or more of the issues described above would be advantageous.

### SUMMARY OF THE INVENTION

In a first aspect, the invention is directed to a connector for connecting a medical device to a support member on a patient support device, such as a stretcher. The connector includes a support member connector that is fixedly connectable to the support member and a device connector for fixedly connecting to the medical device. The device connector is movable relative to the support member connector between a first position wherein the device connector is positioned to hold the medical device adjacent the patient support device and a second position that is inboard of the first position relative to the patient support device.

In a second aspect, the invention is directed to a medical device system including a medical device and a support member connector that is fixedly connectable to a support member on a patient support device. The medical device is connected to the support member connector and is movable relative to the support member connector between a first position wherein the medical device is positioned to be adjacent the patient support device and a second position that is inboard of the first position relative to the patient support device.

In a third aspect, the invention is directed to a connector for selectively connecting a medical device to a first support member on a first side of a patient support device or to a second support member on a second side of a patient support device. The connector includes a support member connector that is fixedly connectable to the support member and a first device connector for fixedly connecting to a first side of the medical device and a second device connector for fixedly connecting to a second side of the medical device. The support member connector is connectable at least indirectly to the first and second device connectors and is selectively positionable in a first orientation relative to the first and second device connectors for connection to the first support member, and a second orientation relative to the first and second device connectors for connection to the second support member.

In a fourth aspect, the invention is directed to a connector including a clamp, a floor engaging surface and a limit member. the clamp includes an upper jaw and a lower jaw hingedly connected to the upper jaw. The upper and lower jaws are movable between a fully closed position and a fully open position.

The clamp is connectable to a device. The limit member is movable between a working position and a stowed position. In the working position the limit member limits opening of the upper and lower jaws beyond a selected maximum opening size. In the stowed position the floor engaging surface is positioned to engage a floor to support the connector and device.

### BRIEF DESCRIPTION OF THE DRAWINGS

The present invention will now be described by way of example only with reference to the attached drawings, in which:

FIG. 1 is a perspective view of a medical device, a stretcher and a set of connectors for connecting the medical device to the stretcher in accordance with an embodiment of the present invention;

FIG. 2 is a magnified perspective view of one of the connectors shown in FIG. 1;

FIG. 3 is a magnified perspective view of another one of the connectors shown in FIG. 1;

FIG. 4 is an elevation view of the connector shown in FIG. 2 in a first position;

FIG. 5 is another elevation view of the connector shown in FIG. 2 in an intermediate position;

FIG. 6 is another elevation view of the connector shown in FIG. 2 in a second position;

FIG. 7 is an elevation view of a connector in accordance with another embodiment of the present invention;

FIGS. 8a-8f are elevation views of the connector shown in FIG. 2 illustrating a sequence of events from a connection to one side of the stretcher shown in FIG. 1 to the other side of the stretcher;

FIG. 9a is another magnified perspective view of the connector shown in FIG. 2; showing a support member connector with a limit member in a stowage position, showing a clamp with a limit member in a working position;

FIG. 9b is another magnified perspective view of the connector shown in FIG. 2, showing the clamp in a fully closed position with a limit member in a stowage position; and

FIG. 9c is another magnified perspective view of the connector shown in FIG. 2, showing the clamp in a fully open position.

### DETAILED DESCRIPTION OF THE INVENTION

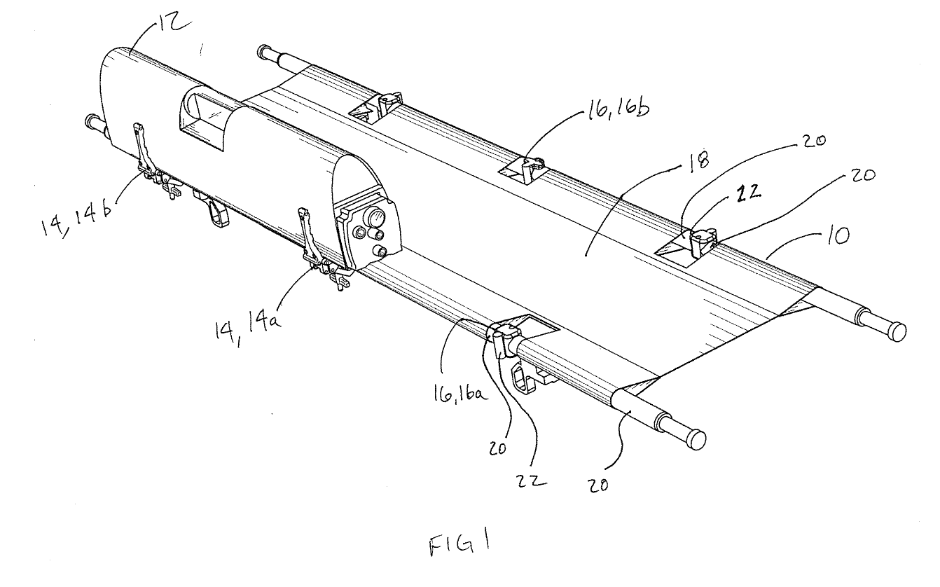

Reference is made to FIG. 1, which shows a stretcher 10, a medical device 12, and a set of connectors 14, individually shown at 14a and 14b, in accordance with an embodiment of the present invention. The stretcher 10 may be any suitable type of stretcher, such as a NATO litter. The stretcher 10 may include first and second support members 16, shown individually at 16a and 16b, and a patient supporting panel 18 supported between the first and second support members 16a and 16b.

The first and second support members 16a and 16b may be substantially identical but for being mirror images of one another. Each support member 16 may include a plurality of support member segments 20 that are connected to each other end-to-end via joints 22.

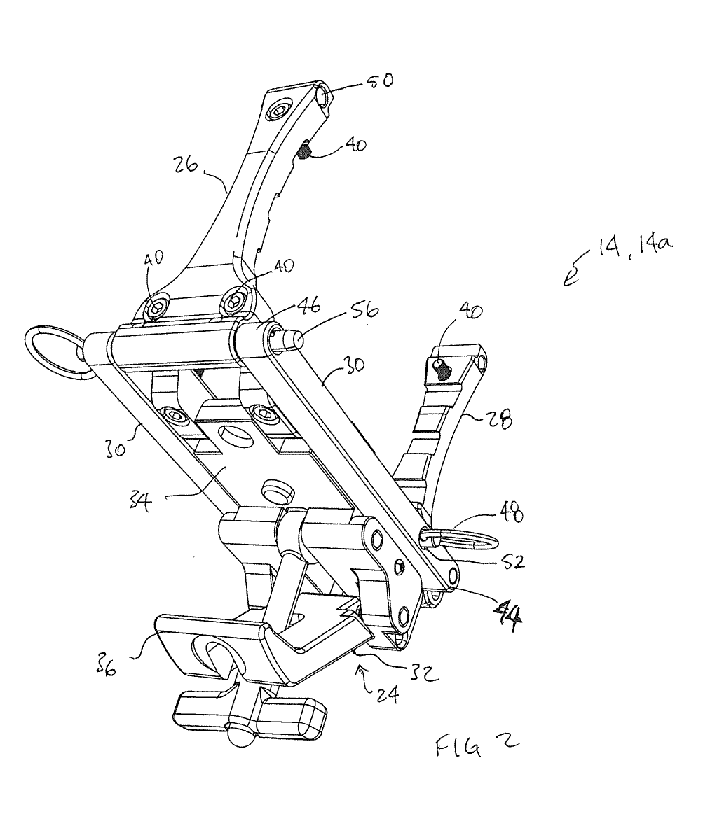

The connectors 14 are used to hold the medical device 12 on the stretcher 10. Referring to FIG. 2, the connector 14a includes a support member connector 24, a first device connector 26, a second device connector 28, and a pair of link arms 30. The support member connector 24 may be any suitable type of connector, and may include, for example, a clamp 32. The clamp 32 includes an upper jaw 34 and a lower jaw 36.

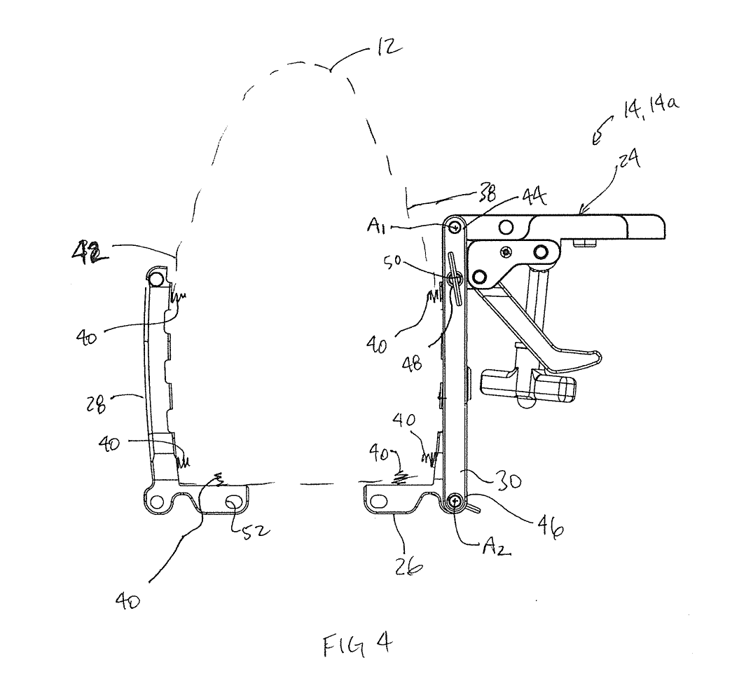

Referring to FIG. 4, the first device connector 26 is configured to fixedly connect to a first side 38 of the medical device 12 and may connect to the medical device 12 by any suitable means, such as by means of a plurality of threaded fasteners 40 mating with threaded apertures (not shown) on the medical device 12 (FIG. 1).

The second device connector 28 is configured to fixedly connect to a second side 42 of the medical device 12, which may be opposed to the first side 38, and may connect to the medical device 12 by any suitable means, such as by means of a plurality of threaded fasteners 40 mating with threaded apertures (not shown) on the medical device 12 (FIG. 1).

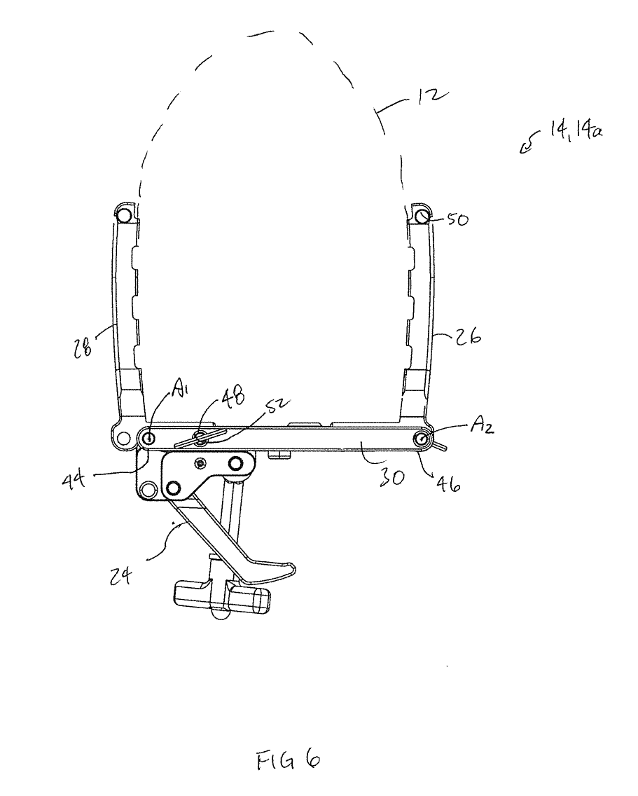

Referring to FIGS. 4, 5 and 6, the device connectors 26 and 28 are movable relative to the support member connector 24 between a first position shown in FIG. 4 wherein the device connectors 26 and 28 are positioned to hold the medical device 12 adjacent the stretcher 10 and a second position shown in FIG. 6 wherein the device connectors 26 and 28 are positioned to hold the medical device 12 above the stretcher 10. In the first position, the medical device 12 is off the patient support panel 18 so as not to impinge on the available space for a patient (not shown) on the stretcher 10. The second position is inboard of the first position so that the medical device 12 is less likely to interfere with the maneuvering of the stretcher 10 into position between stretcher-supporting stanchions (not shown) in a transport vehicle (not shown) such as a helicopter.

In an alternative embodiment that is not shown, it is possible for the second position to correspond to holding the medical device 12 and the device connectors 26 and 28 below the stretcher 10 instead of holding them above the stretcher 10. It is, however, preferable to hold them above the stretcher 10 for easier access by a medical device operator, such as a physician.

It will be noted that the orientation of the first and second device connectors 26 and 28 in the second position is the same as their orientation in the first position. This is advantageous in that the medical device 12 need not be reoriented for use when being moved between the first and second positions.

Movement between the first and second positions is achieved by means of the link arms 30. The link arms 30 each have a first end 44 and a second end 46. The support member connector 24 is rotatably connected to the first end 44 about a first axis A1 and one of the first and second device connectors 26 and 28 is rotatably connected to the second end 46 about a second axis A2. The axis A2 is preferably generally parallel to the axis A1.

A connector position locking pin 48 is provided to lock the connector 14a in each of the first and second positions. When the connector 14a is in the first position, the connector position locking pin 48 may pass through a first position locking aperture 50 that extends through the link arms 30, the support member connector 24 and the first device connector 26. When the connector 14a is in the second position, the connector position locking pin 48 may pass through a second position locking aperture 52 that extends through the link arms 30, the support member connector 24 and the second device connector 28, as shown in FIG. 6. The connector position locking pin 48 may be any suitable type of pin, such as a ball detent pin. Alternatively, any other suitable locking means may be provided.

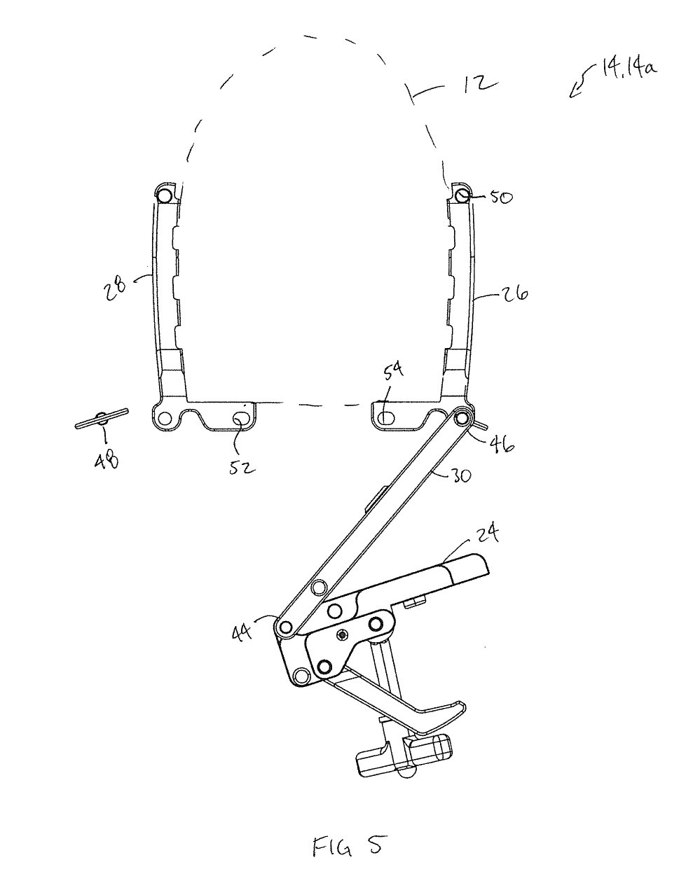

To move from the first position (FIG. 4) to the second position (FIG. 6), the connector position locking pin 48 is removed from the first position locking aperture 50. The medical device 12 is moved from the position shown in FIG. 4 through the intermediate position shown in FIG. 5 to the position shown in FIG. 6. The connector position locking pin 48 is inserted into the second position locking aperture 52.

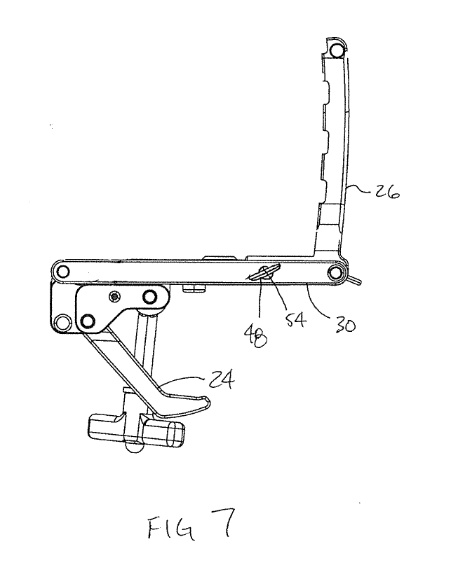

For the purposes of movement between the first and second positions and for holding the connector 14a in the first and second positions it will be noted that the second device connector 28 is not a necessary component and may be omitted. In such cases where the second device connector 28 is omitted, the connector position locking pin 48 may instead pass through an aperture shown at 54 that passes through the link arms 30, the support member connector 24 and the first device connector 26 (see FIG. 7).

While two link arms 30 are shown in the Figures, it will be apparent that any suitable number of link arms 30 may be provided, such as one link arm 30

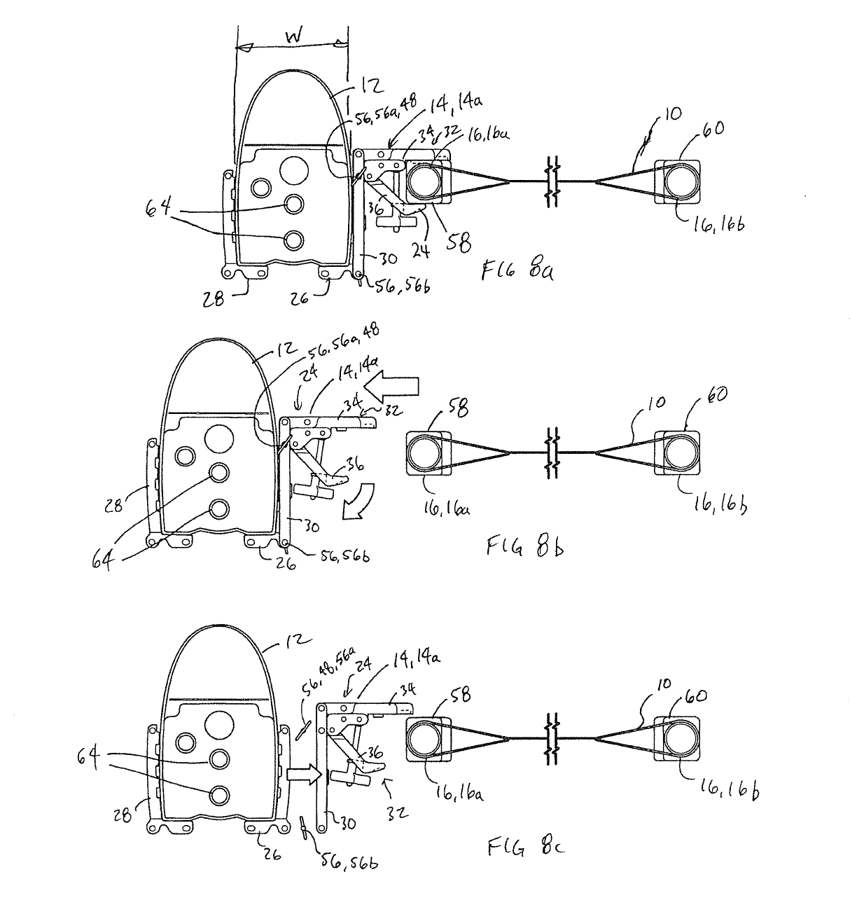

Referring to FIG. 2, the connector 14a may further include one or more support member connector orientation locking pins 56 that lock the support member connector 24 selectively in either a first orientation (FIG. 8a) relative to the device connectors 26 and 28 for mounting on a first side 58 of the stretcher 10, or a second orientation (FIG. 8f) relative to the device connectors 26 and 28 for mounting on a second side 60 of the stretcher 10. One of the support member connector orientation locking pins is shown at 56a and may be the connector position locking pin 48. Another support member connector orientation locking pin is shown at 56b and forms the rotatable connection between the link arms 30 and one of the first and second device connectors 26 and 28, thereby indirectly connecting the support member connector 24 to one of the first and second device connectors 26 or 28 (specifically the device connector 26 in FIG. 8a and the device connector 28 in FIG. 8f).

The sequence of Figures from FIG. 8a to FIG. 8f illustrates the removal of the medical device 12 from the first side 58 of the stretcher 10 and the remounting of it to the second side 60 of the stretcher 10. Specifically, FIG. 8a shows the medical device 12 and connector 14a connected to the support member 16a on the first side 58 of the stretcher 10. As shown in FIG. 8b, the medical device 12 and the entire connector 14a including the support member connector 24 may be removed from the support member 16a (eg. by opening of the clamp jaws 34 and 36 in embodiments wherein the support member connector 24 includes a clamp 32). As shown in FIG. 8c, the support member connector 24 is separated from the first device connector 26 by removal of the support member connector orientation locking pins 56. As shown in FIG. 8d, the support member connector 24 is reoriented from its first orientation (FIG. 8c) to its second orientation (FIG. 8d), which may be generally opposed to its first orientation. As shown in FIG. 8e, the support member connector orientation locking pins 56 are reinserted to lock the support member connector 24 to the second device connector 28, and to lock the connector 14a in the first position (ie. so that the medical device is held adjacent the stretcher 10). As shown in FIG. 8f, the medical device 12 and the connector 14a are mounted to the support member 16b on the second side 60 of the stretcher 60 (eg. by closing of the clamp jaws 34 and 36).

By quickly being able to change the orientation of the support member connector 24 on the connector 14, the medical device 12 can be moved easily and quickly from the left side of one stretcher 10 to the right side of another, while remaining in the same orientation. In this way, features that are desirable to have positioned close to a patient's head can be kept close to the patient's head regardless of whether the medical device 12 is on the left side or right side of the stretcher 10. For example, for certain types of medical device 12, a first end face 62 of the medical device 12 may include connections 64 for breathing tubes (not shown) from an oxygen mask (not shown). It is therefore desirable to have the first end 62 facing the patient's head (not shown). It is thus advantageous to be able to adjust the connectors 14 to permit the medical device 12 to be mounted to either side of the stretcher 10 while maintaining its orientation.

It will be noted that the sequence of events illustrated in FIGS. 8a-8f need not take place precisely in the order shown. For example, it is alternatively possible to initially remove the medical device 12 and the attached device connectors 26 ad 28 from the support member connector 24 while the support member connector 24 remains connected to the first side 58 of the stretcher 10, and then to remove the support member connector 24 from the stretcher 10. Similarly, it is possible to mount the support member connector 24 to the second side 60 of the stretcher 10 prior to locking of the medical device 12 and associated device connectors 26 and 28 to the support member connector 24 by means of the support member connector orientation locking pins 56.

To return the medical device 12 from the second side 60 of the stretcher 10 to the first side 58, the steps illustrated in FIGS. 8a-8f may be taken in reverse.

Once the support member connector orientation locking pin 56b is in place and connects the link arms 30 to one of the device connectors 26 and 28, the connector 14a is selectively movable between its first and second positions to hold the medical device 12 adjacent to or on top of the stretcher 10.

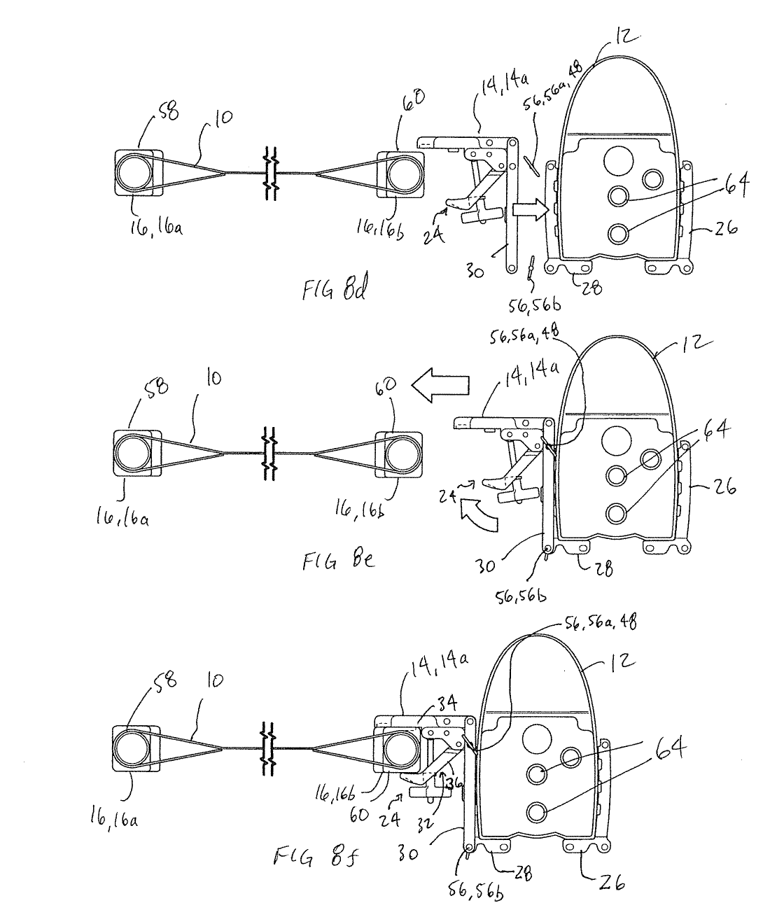

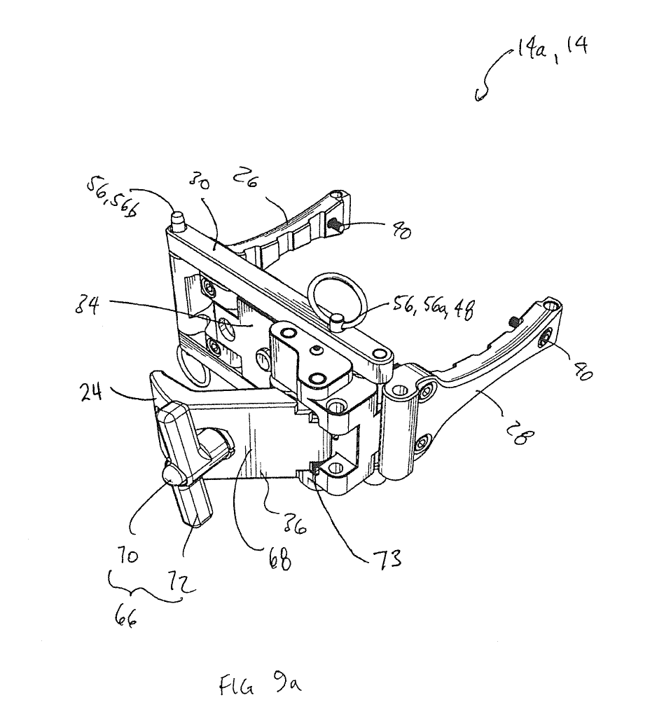

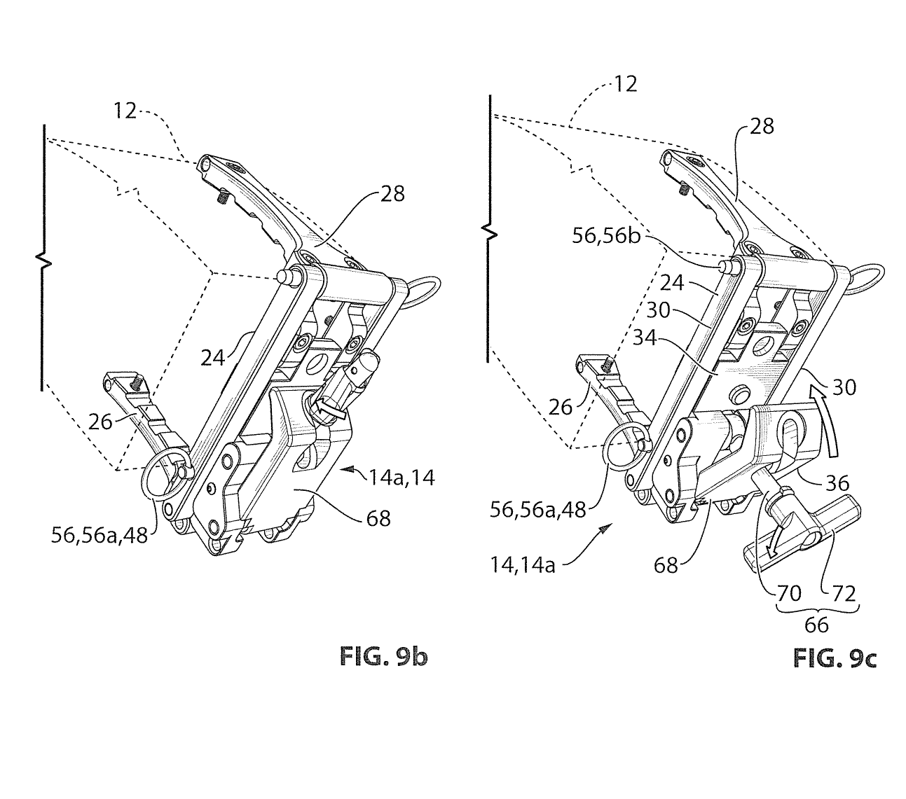

Reference is made to FIGS. 9a, 9b and 9c which show the support member connector 24 in more detail. The support member connector 24 may include the aforementioned clamp 32 and a limit member 66. The clamp jaws 34 and 36 are movable between a fully open position (FIG. 9a) and a fully closed position (FIG. 9b). The limit member 66 is movable between a working position (FIGS. 9a or FIG. 9c) and a stowed position (FIG. 9b). In the working position, the limit member 66 limits opening of the clamp jaws 34 and 36 beyond a selected maximum opening size (eg. an example of which is shown in FIG. 9c) towards the fully open position. In the stowed position, the limit member 66 is rotated out of the way so that when the connector 14a is in the second position and the medical device 12 with attached connector 14a is placed on a support surface (eg. a floor, not shown), a generally horizontal floor engaging surface 68 on the connector 14a engages the floor to support the medical device 12. The floor engaging surface 68 may be any selected part of the connector 14a, such as, for example, the underside of the lower clamp jaw 36.

The limit member 66 may have any suitable structure. For example, the limit member 66 may be made up of a threaded rod 70 and a handle 72 that is internally threaded for movement along the length of the threaded rod 70 and which is engageable with the lower clamp jaw 36 to set the selected maximum opening size of the clamp jaws 34 and 36. In a preferred embodiment, the threaded rod passes through an aperture in the lower jaw and is captured so that there is no way for the lower jaw 36 to bypass the handle 72.

It is alternatively possible to have the threaded rod 70 pivotally connected to the lower clamp jaw 36 and to have the handle 72 engage the upper clamp jaw 34.

The clamp jaws 34 and 36 may be biased towards their fully open position. To this end a clamp jaw biasing member 73 may be provided, which may be any suitable type of biasing member, such as, for example, a torsion spring.

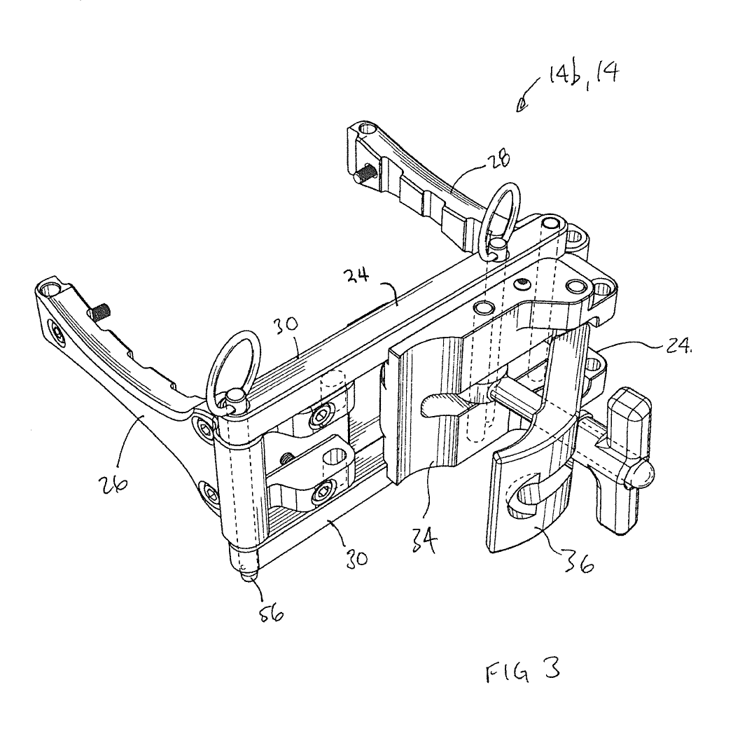

Reference is made to FIG. 1. The connector 14b may be similar to the connector 14a, but is configured to hold the support member 16 at a different position than the connector 14a. For example, the connector 14a may be configured to hold the support member 16 at a joint 22, whereas the connector 14b may be configured to hold the support member 16 along a support member segment 20. Accordingly, the shapes of the clamp jaws 34 and 36 may be slightly differently configured on the connector 14a than on the connector 14b to accommodate the particular portions of the support member 16 that each connector 14 clamps onto. FIG. 3 shows the clamp 32 on the connector 14b in more detail.

In the figures and description a stretcher 10 has been used to illustrate the operation of the connectors 14. It is alternatively possible for the stretcher 10 to be some other suitable type of patient support device, such as a gurney or a hospital bed.

In the figures, the first and second device connectors 26 and 28 have been shown to be two separate members that mount individually to the medical device 12. It is alternatively possible for the two device connectors 26 and 28 to be integrally connected together in a single U-shaped member.

The medical device 12 may be any suitable type of medical device, and may be configured to provide diagnostic information concerning the patient or may be configured to provide some form of treatment (eg. oxygen) to the patient or may be configured to provide both diagnostic information and treatment to the patient.

The figures show two connectors being used to connect the medical device 12 to the stretcher 10. It is alternatively possible for any other suitable number of connectors 14 to be used. For example, it is possible that a single connector 14 could be used, or alternatively three or more connectors 14 could be used.

The medical device 12 could be configured to receive the link arms 30 directly instead of receiving the device connectors 26 and 28. In such an embodiment, whatever means are provided to connect the link arms 30 to the medical device 12 could be considered to be device connectors. For example, if bolts (not shown) are provided that each have an unthreaded portion that acts as a shaft for a link arm 30 and that has a threaded portion for mounting in a threaded aperture in the medical device 12 then the bolts would be considered to be device connectors.

The configuration of the medical device 12 is preferably relatively narrow in width. The width is shown in FIG. 8a as W. By having a narrow width, the medical device 12 occupies less pass-through space beside the stretcher 10 when the medical device 12 is positioned beside the stretcher 10, and also occupies relatively little patient support area on the stretcher 10 when the medical device 12 is positioned above the stretcher 10.

As a result of the narrow width W of the medical device 12, the medical device 12 may be elongate in order for it to contain all the desired components, and may be relatively tall. By extending the length and/or height of the medical device 12 the width W can be kept relatively narrow.

While the above description constitutes a plurality of embodiments of the present invention, it will be appreciated that the present invention is susceptible to further modification and change without departing from the fair meaning of the accompanying claims.

1. A connector for connecting a medical device to a support member on a patient support device of the type having a horizontally-oriented patient support surface for supporting a patient in a recumbent position, comprising:
a support member connector that is fixedly connectable to the support member;
a device connector for fixedly connecting to the medical device; and
at least one link arm having a first end and a second end;
wherein the support member connector is rotatably connected to the first end of the at least one link arm for rotation about a first axis, and wherein the device connector is rotatably connected to the second end of the at least one link arm for rotation about a second axis, and wherein the first axis is generally parallel to the second axis and to the horizontally oriented patient support surface; and
wherein the device connector is movable relative to the support member connector between a first position in which the device connector is positioned to hold the medical device adjacent the patient support device and a second position that is inboard of the first position relative to the patient support surface in which the medical device is closer to the patient relative to the first position, and wherein rotation of the support member connector about the first axis coupled with rotation of device connector about the second axis moves the second end of the link arm inboard relative to the patient support surface and moves the device connector between the first position and the second position.

2. A connector as claimed in claim 1, wherein the support member is a frame member of a stretcher.

3. A connector as claimed in claim 1, wherein the orientation of the device connector in the first position is substantially the same as the orientation of the device connector in the second position.

4. A connector as claimed in claim 1, wherein the device connector is lockable in the first and second positions.

5. A connector as claimed in claim 1, wherein the support member is a horizontally oriented frame member of a patient support device and wherein movement of the device connector from the first position to the second position moves the second end of the link arm though an arc of rotation extending from a position beneath the side frame member to a position in which the second end of the link of the link arm overlies the side frame member.

6. A connector as claimed in claim 3, wherein the support member is a horizontally oriented frame member of a patient support device and wherein movement of the device connector from the first position to the second position moves the second end of the link arm though an arc of rotation extending from a position beneath the side frame member to a position in which the second end of the link of the link arm overlies the side frame member.

7. A connector as claimed in claim 1, wherein the at least one link arm has a first side and a second side and wherein the device connector rotates from a position on the first side of the link arm towards a position on the second side of the link arm when the device connector is moved between the first position and the second position.

8. A connector as claimed in claim 5, wherein the at least one link arm has a first side and a second side and wherein the device connector rotates from a position on the first side of the link arm towards a position on the second side of the link arm when the device connector is moved between the first position and the second position.

9. A connector as claimed in claim 1, wherein the device connector in the second position is positioned to hold the medical device immediately above the patient support device.

10. A connector as claimed in claim 2, wherein the device connector in the second position is positioned to hold the medical device immediately above the frame member of the stretcher.

11. A connector as claimed in claim 1, wherein the at least one link arm is made of a rigid material which defines a fixed distance between the first axis and the second axis and a maximum radius of travel of the device connector relative the support member connector that constrains the radius of movement of the medical device relative to the support member when the medical is rotated between the first position and the second position.

12. A connector as claimed in claim 1, wherein the at least one link arm includes two link arms.

13. A medical device system for connection to a support member on a patient support device of the type having a horizontally-oriented patient support surface for supporting a patient in a recumbent position, comprising:
a medical device;
at least one link arm having a first end and a second end; and
a support member connector that is fixedly connectable to the support member;
wherein the support member connector is rotatably connected to the first end of the at least one link arm for rotation about a first axis, and wherein the medical device is rotatably connected to the second end of the at least one link arm for rotation about a second axis, and wherein the first axis is generally parallel to the second axis and to the horizontally oriented patient support surface, and wherein the medical device is movable relative to the support member connector between a first position wherein the medical device is positioned adjacent the patient support device and a second position that is inboard of the first position relative to the patient support device in which the medical device is positioned closer the patient relative to the first position, and wherein rotation of at least one link arm about the first axis coupled with rotation of the medical device about the second axis moves the second end of the link arm inboard relative to the patient support surface and moves the medical device between the first position and the second position.

13. A medical device system as claimed in claim 12, further comprising a device connector that is fixedly connectable to the medical device and to the second end of the at least one link arm.

14. A connector as claimed in claim 13, wherein the orientation of the medical device in the first position is substantially the same as the orientation of the medical device in the second position.

15. A connector as claimed in claim 12, wherein the support member is a frame member of a stretcher.

16. A medical device system as claimed in claim 9, wherein the medical device is immediately above the patient support device in the second position.

17. A connector as claimed in claim 12, wherein the support member is a horizontally oriented frame member of a patient support device and wherein rotation of the second end of the link arm moves the medical device though an arc of rotation extending from a position beneath the side frame member to a position in which the second end of the link of the link arm is inboard of the side frame member.

18. A connector for connecting a medical device in an upright usable position to a support member on a patient support device of the type having a horizontally-oriented patient support surface for supporting a patient in a recumbent position, comprising:
a support member connector that is fixedly connectable to the support member; and
a device connector for fixedly connecting to the medical device;
and wherein the support member connector includes:
a floor engaging surface;
a clamp including an upper jaw and a lower jaw hingedly connected to the upper jaw, wherein the upper and lower jaws are movable between a fully closed position and a fully open position;
a limit member that is movable, without detachment, between a working position in which the opening of the upper and lower jaws is limited beyond a selected maximum opening size, wherein the upper and lower jaws are positioned to receive the support member for connection thereto, and a stowed position in which the floor engaging surface is configured to directly engage a floor and support the medical device on the floor in an upright usable position.

19. A connector as claimed in claim 18, wherein the upper and lower jaws are biased towards the fully open position.

20. A connector as claimed in claim 18, wherein the limit member is adjustable to adjust the selected opening size of the upper and lower jaws.

21. A connector as claimed in claim 19, wherein the limit member includes a threaded rod that is pivotally connected to one of the upper and lower jaws and a handle that is threaded that is movable along the length of the threaded rod and that is engageable with the other of the upper and lower jaws to set the selected maximum opening size.

22. A connector as claimed in claim 18, wherein the orientation of the device connector in the first position is substantially the same as the orientation of the device connector in the second position.

23. A connector as claimed in claim 18, wherein the support member is a horizontal frame member of a patient support surface and wherein the device connector is movable between the first position and the second position about an axis parallel to the frame member.

24. A connector as claimed in claim 18, wherein the device connector is lockable in the first and second positions.

25. A connector as claimed in claim 23, further comprising at least one link arm having a first end and a second end, wherein the support member connector is rotatably connected to the first end of the at least one link arm for rotation about a first axis and wherein the device connector is rotatably connected to the second end of the at least one link arm for rotation about a second axis that is generally parallel to the first axis.

26. A connector as claimed in claim 25, wherein the at least one link arm is two link arms configured to define a plane that includes the first axis and the second axis.

27. A connector as claimed in claim 18, wherein the support member is a horizontally oriented side frame member of stretcher and wherein the medical device is configured to occupy an elongated horizontal profile of relatively narrow width, and wherein the device connector, in the second position, is configured to hold the medical device immediately above the side frame member in a longitudinal horizontal position parallel to the side frame member.
